(19) United States
(12) Patent Application Publication
(10) Pub. No.: US 2022/0237571 A1
(43) Pub. Date: Jul. 28, 2022

(54) Board Signage Safety System and Method for Use of Same

(71) Applicant: RailPros Field Services, Inc., Irving, TX (US)

(72) Inventor: James McDonald, Irving, TX (US)

(21) Appl. No.: 17/621,855

(22) PCT Filed: Jun. 29, 2020
(86) PCT No.: PCT/US20/40066

§ 371 Date: Dec. 22, 2021

Related U.S. Application Data
(60) Provisional application No. 62/868,249, filed on Jun. 28, 2019.

(51) Int. Cl. G06Q 10/00; G06Q 10/06; H04W 4/02; G09F 7/00

(52) U.S. Cl. CPC G06Q 10/20; G09F 7/00; H04W 4/025; G06Q 10/063114

(57) ABSTRACT

A board signage safety system (10) and a method for use of the same are disclosed. In one embodiment of the system, a board signage establishment plan stored on a server (50) includes a schedule of sign establishment locations and sign identification data for multiple signs (22-30), such as signs used in construction, maintenance, and the like. Similarly, a board signage disestablishment plan stored on the server (50) includes a schedule of sign disestablishment locations with sign identification data. Field crewmembers (18, 20) utilize the board signage establishment plan on a smart device (32) to correctly install the signs (22-30) and the field crewmembers (18, 20) utilize the board signage disestablishment plan on the smart device (32) to correct dismantle the signs (22-30).

### TECHNICAL FIELD OF THE INVENTION

This invention relates, in general, to board signage and, in particular, to a board safety signage system and a method for use of the same for use in construction and maintenance operations to avoid catastrophic events and protect workers.

### BACKGROUND OF THE INVENTION

Without limiting the scope of the invention, the background will be described with reference to maintenance of railway projects, as an example. During the maintenance of railroads, board signage is utilized to protect trains, train crews, contractors, and anyone performing work within a railway right-of-way. The board signage informs the individuals in the area of the conditions and provide guidance that prioritizes safety. Critical to maintaining safety is the timely installation or “establishment” of board signage and the timely dismantling or “disestablishment” of the board signage. During such maintenance, railway workers are frequently assigned the task of establishment and disestablishment. Typically, railway workers rely on manual logs to record the establishment and disestablishment. These practices have been in place for decades despite technology improvements in many other areas. As a result, there is a need for improved establishment and disestablishment of board signage.

### SUMMARY OF THE INVENTION

It would be advantageous to mitigate the risks of improper board signage establishment or disestablishment in the railway industry and other construction and maintenance operations, for example. It would also be desirable to enable a computer-based solution that is easily and quickly deployed without the need for a complex technical analysis. To better address one or more of these concerns, a board signage safety system and a method for use of the same are disclosed. In one embodiment of the system, a board signage establishment plan stored on a server includes a schedule of sign establishment locations and sign identification data for multiple signs, such as signs used in construction, maintenance, and the like. Similarly, a board signage disestablishment plan stored on the server includes a schedule of sign disestablishment locations with sign identification data. Field crewmembers utilize the board signage establishment plan on a smart device to correctly install the signs and the field crewmembers utilize the board signage disestablishment plan on the smart device to correctly dismantle the signs.

In one embodiment of the method, a board signage establishment plan and a board signage disestablishment plan are created at a server. In particular, the board signage establishment plan and the board signage disestablishment plan may be integrated into a calendar associated with field crewmember smart devices. During board signage installation, the board signage establishment plan is utilized by field crewmembers to acknowledge the establishment of a particular sign and receive a verification status in response. During board signage dismantling, the board signage disestablishment plan is utilized by field crewmembers to acknowledge the disestablishment of a particular sign and receive a verification status in response. This board signage system safety and the method for use of the same as well as other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1A is a schematic block diagram depicting one embodiment of a board signage safety system being utilized for the establishment of signage, according to the teachings presented herein;

FIG. 1B is a schematic block diagram depicting one embodiment of a board signage safety system being utilized for the disestablishment of signage, according to the teachings presented herein;

FIG. 2 is a functional block diagram depicting one embodiment of a smart device shown in FIG. 1, which may form a portion of the system;

FIG. 3 is a functional block diagram depicting one embodiment of a server shown in FIG. 1, which may form a portion of the system;

FIG. 4 is a conceptual module diagram depicting a software architecture of a board signage safety application of some embodiments;

FIG. 5 is a signalization diagram depicting one embodiment of signal communication during an establishment of board signage;

FIG. 6 is a signalization diagram depicting one embodiment of signal communication during a disestablishment of board signage;

FIG. 7 is a flowchart depicting one embodiment of a method for board signage safety utilizing establishment of board signage, according to the teachings presented herein; and

FIG. 8 is a flowchart depicting one embodiment of a method for board signage safety utilizing disestablishment of board signage, according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of several specific ways to make and use the invention, and do not delimit the scope of the present invention.

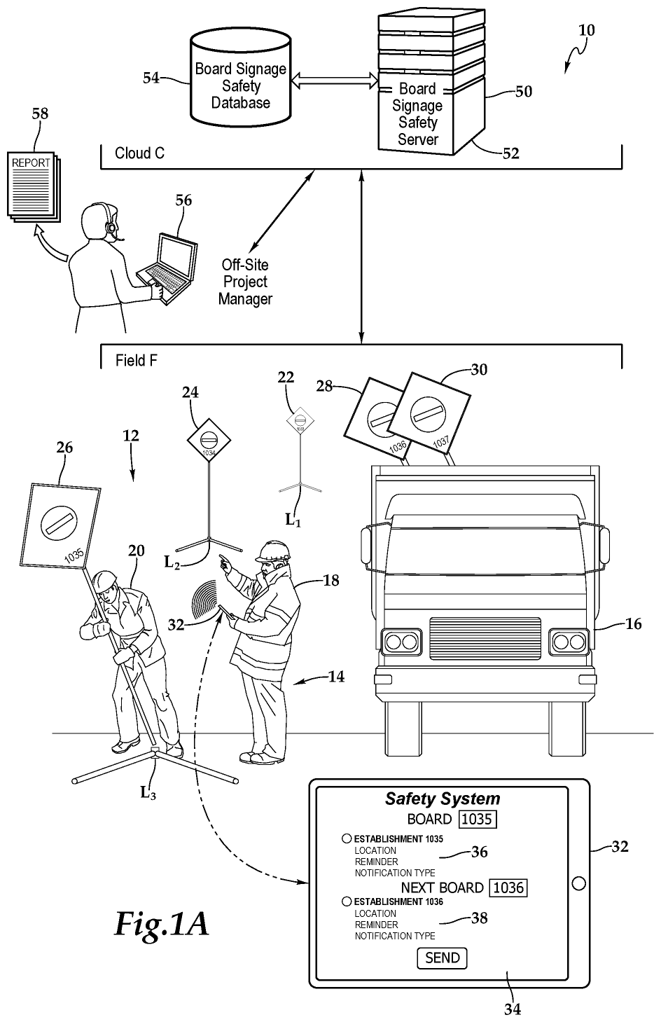

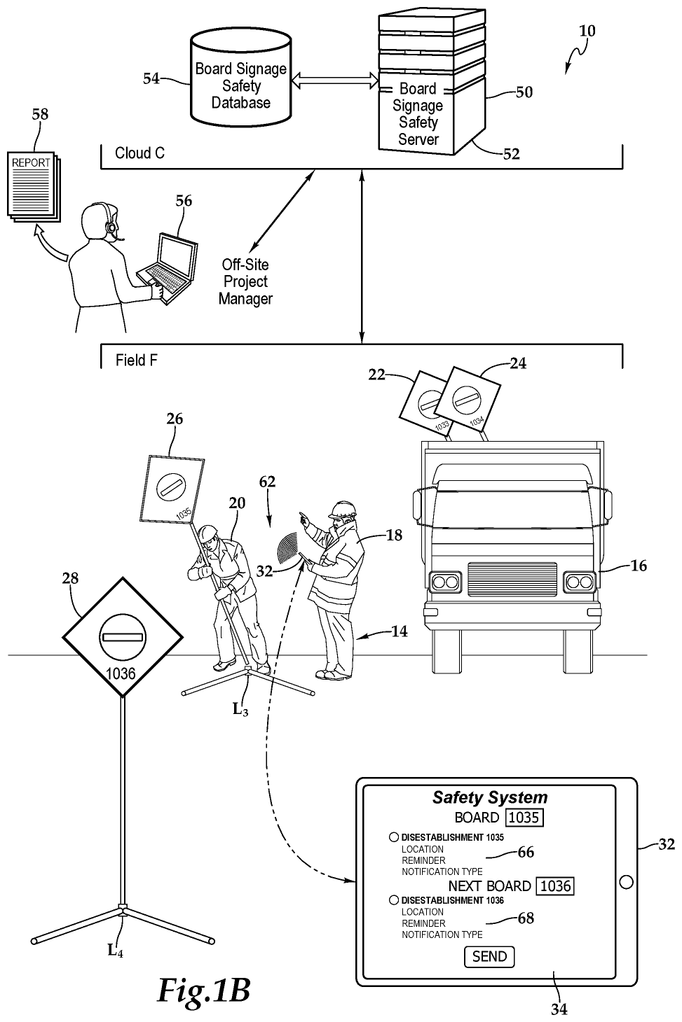

Referring initially to FIG. 1, therein is depicted one embodiment of a system for providing board signage safety that is schematically illustrated and generally labeled 10. A board signage establishment operation 12 is underway in field F. A board signage team 14, which includes a vehicle 16, a field crewmember 18, and a field crewmember 20, is deployed in the field F to execute the board signage establishment operation 12. As part of a board signage establishment plan, the field crewmembers 18, 20 have already established a sign 22 at location L₁ and a sign 24 at a location L₂. The field crewmembers 18, 20 are installing a sign 26 at a location L₃. Signs 28, 30 are stored in the vehicle 16 for installation at other locations as part of the board signage establishment operation 12.

As depicted, the field crewmember 18 is utilizing a smart device 32 having a display 34 to access the board signage establishment plan. The display 34 includes a schedule of sign establishment locations and sign identification data for each of the signs 22-30, with data 36 displayed for the sign 26 and data 38 displayed for the sign 28. With respect to the data 36, the board signage establishment plan indicates the sign 26 is labeled “1035” and is being established at the location L₃. The data 36 also presents the field crewmember 18 with information about when reminders regarding establishment and any known disestablishment will occur as well as the notification types that will be utilized. The notification types include, but are not limited to, “in-app” notices, which are audio, visual, or audio visual or “out-app” notices, which may be text messages, emails, or telephone calls, for example. Further, the board signage establishment plan may be integrated into a calendar associated with the smart device 32. Similarly, with respect to the data 38, the board signage establishment plan indicates the sign 28 is labeled “1036” and is being established at the location L₄ (see FIG. 1B). The data 38 also presents the field crewmember 18 with information about when reminders regarding establishment and any known disestablishment will occur as well as the notification types that will be utilized.

A board signage safety server 50 is remotely located to the field F in a cloud C. It should be appreciated, however, that the board signage safety server 50 may be located in any remote location, including non-cloud-based locations. As shown, the board signage safety server 50 having a housing 152 has access to a board signage safety database 54 to provide an interface and functionality to the field F, including the smart device 32 associated with the field crewmember 18 of the board signage field team 14. An off-site project manager 56 is located in communication with the services offered by the cloud C. The off-site project manager 56 may run various reports 58 to give visibility into how the board signage field team 14 is functioning. This can also identify any potential hazardous operations.

In one operational implementation, the field crewmembers 18, 20 in the field F utilize the smart device 32 as part of a program to complete the board signage establishment plan, wherein the smart device 32 offers an application that accesses the board signage establishment plan from the board signage safety server 52. As the field crewmember 20 completes the installation of the sign 26, the field crewmember 20 utilizes the smart device 32 to establish a pairing with the sign 26 by verifying the data 36 or, if necessary, entering at least a portion of the data 36. The pairing may include verification and/or entry of the data 36. Once the sign 26 is established, the field crewmember 20 sends an acknowledgment to the board signage safety server 50 including the sign identification data reflected in data 36 with global positioning system (GPS) data, which may include time and location information as part of the GPS data. The board signage safety server 50 receives the information and verifies the information. The board signage safety server 50 then sends a verification signal to the smart device 32 indicating a notification of correct installation of the sign 26 or a notification of incorrect installation of the sign 26. The board signage team 14 may then proceed accordingly by advancing to the next sign requiring establishment or re-establishing the sign 26, if necessary.

Referring now to FIG. 1B, as shown, a board signage disestablishment operation 62 is underway in field F. The field crewmember 18 is utilizing the smart device 32 to monitor the operation of the dismantling of the signs 22-28. With respect to data 66, the board signage disestablishment plan indicates the sign 26 is labeled “1035” and is being disestablished at the location L₃. The data 36 also presents the field crewmember 18 with information about when reminders regarding disestablishment will occur as well as the notification types that will be utilized. The notification types include, but are not limited to, “in-app” notices, which are audio, visual, or audio visual or “out-app” notices, which may be text messages, emails, or telephone calls, for example. Further, the board signage disestablishment plan may be integrated into a calendar associated with the smart device 32. Similarly, with respect to data 68, the board signage disestablishment plan indicates the sign 28 is labeled “1036” and is being disestablished at the location L₄. The data 38 also presents the field crewmember 18 with information about when reminders regarding disestablishment will occur as well as the notification types that will be utilized.

More particularly, as the field crewmember 20 completes the dismantling of the sign 26, the field crewmember 20 utilizes the smart device 32 to send an acknowledgment to the board signage safety server 50 including the sign identification data reflected in data 66 with global positioning system (GPS) data. The board signage safety server 50 receives the information and verifies the information. The board signage safety server 50 then sends a verification signal to the smart device 32 indicating a notification of correct dismantling of the sign 26 or a notification of incorrect dismantling of the sign 26. The board signage team 14 may then proceed accordingly by advancing to the next sign requiring disestablishment or correct any dismantling errors with the sign 26, if necessary. As mentioned, the board signage safety server 50 and the smart device 32 provide reminders and warnings, such as an audio notification or visual notification about the board signage disestablishment plan.

With respect to the daily operations by the off-site project manager 56, as part of a safety protocol, the execution of the board signage disestablishment plan is reviewed and checked and submitted to the board signage safety server 50 and the board signage safety database 54 prior to obtaining any necessary signatures or authorization to reopen an area. Any deficiencies may be reviewed by the off-site project manager 56. In the event that a condition exists that is considered a safety issue, the off-site project manager 56 may contact the field crew 14 or take other necessary action.

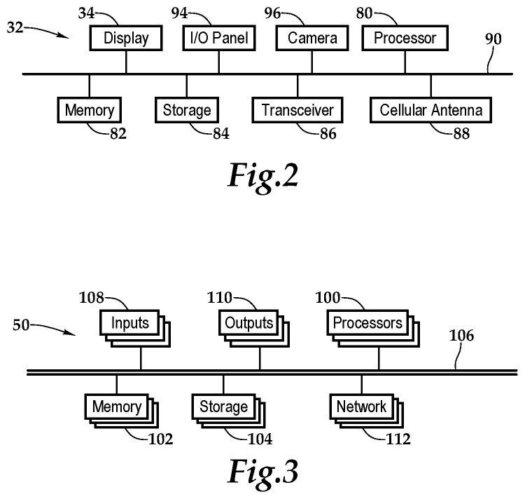

Referring now to FIG. 2, the smart device 32 may be a wireless communication device of the type including various fixed, mobile, and/or portable devices. To expand rather than limit the discussion of the smart device 32, such devices may include, but are not limited to, cellular or mobile smart telephones, tablet computers, smartwatches, and so forth. The smart device 32 may include a processor 80, memory 82, storage 84, a transceiver 86, and a cellular antenna 88 interconnected by a busing architecture 90 that also supports the display 34, I/O panel 94, and a camera 96. It should be appreciated that although a particular architecture is explained, other designs and layouts are within the teachings presented herein.

In operation, the teachings presented herein permit the smart device 32 such as a smart tablet to execute the board signage safety establishment plan and the board signage safety disestablishment plan, facilitate monitoring and reporting, and receive notifications from the board signage safety server 50. As shown, the smart device 32 includes the memory 82 accessible to the processor 80 and the memory 82 includes processor-executable instructions that, when executed, cause the processor 80 to execute various instructions.

In a first embodiment of processor-executable instructions, the processor-executable instructions cause the processor 80 to receive a board signage establishment plan from a remote server, such as the board signage safety server 50. As previously discussed, the board signage establishment plan includes a schedule of sign establishment locations and sign identification data for multiple signs. The processor-executable instructions then cause the processor 80 to establish a pairing with a particular sign according to the board signage establishment plan. The processor 80 then, in response to establishment of the particular sign, sends an acknowledgement to the remote server. The acknowledgment includes sign identification data and GPS data relative to the particular sign. The acknowledgement may be a confirmation of installation of the establishment of the particular sign or, for example, include media, such as photograph or video, of installation of the establishment of the particular sign. With respect to the GPS, the processor-executable instructions may cause the processor 80 to document the location of the signs by augmenting GPS data to the board signage establishment plan. The processor-executable instructions then cause the processor 80 to receive a verification signal from the remote server. As previously alluded, the verification signal indicates a verification status of the establishment of the particular sign, which may be a notification of correct installation relative to the establishment of the particular sign or a notification of incorrect installation relative to the establishment of the particular sign.

In another embodiment of processor-executable instructions, the processor-executable instructions include processor-executable instructions that, when executed, by the processor cause the system to receive a board signage disestablishment plan at a smart device, such as the smart device 32, from a remote server, such as the board signage safety server 50. As discussed, the board signage disestablishment plan includes a schedule of sign disestablishment locations and sign identification data for multiple signs. The processor-executable instructions cause the processor 80 to, in response to disestablishment of the particular sign, send an acknowledgement to the remote server. The acknowledgment may include sign identification data and GPS data relative to the particular sign. The processor 80 may be caused to augment the acknowledgement with GPS data. The acknowledgment may be a confirmation of dismantling of the disestablishment of the particular sign that includes media, such as a photograph or video of the dismantling.

The processor-executable instructions then cause the processor 80 to receive a verification signal from the board signage safety server 50, which provides a verification status of the disestablishment of the particular sign. The verification status may indicate a correct dismantling relative to the disestablishment of the particular sign or an incorrect dismantling relative to the disestablishment of the particular sign.

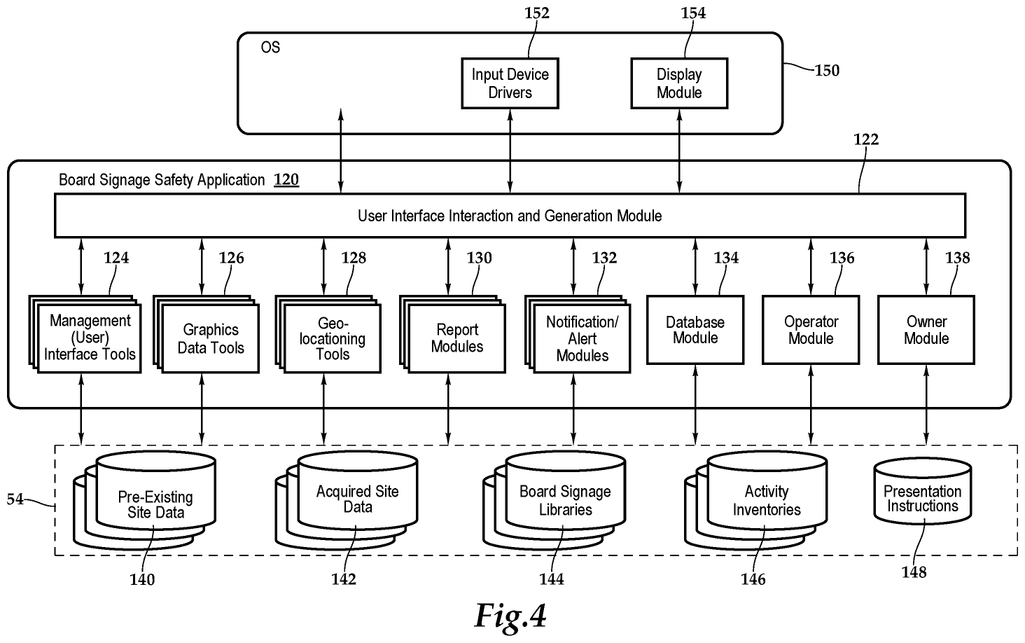

Referring now to FIG. 3, one embodiment of the board signage safety server 50 as a computing device includes, within the housing 52, a processor 100, memory 102, and storage 104 interconnected with various buses 106 in a common or distributed, for example, mounting architecture that also supports inputs 108, outputs 110, and a network interface 112. In other implementations, in the computing device, multiple processors and/or multiple buses may be used, as appropriate, along with multiple memories and types of memory. Further still, in other implementations, multiple computing devices may be provided and operations distributed therebetween. The processor 100 may process instructions for execution within the board signage safety server 50, including instructions stored in the memory 82 or in the storage 104. The memory 102 stores information within the computing device. In one implementation, the memory 102 is a volatile memory unit or units. In another implementation, the memory 102 is a non-volatile memory unit or units. Storage 104 includes capacity that is capable of providing mass storage for the board signage safety server 50, including board signage safety database storage capacity. The various inputs 108 and outputs 100 provide connections to and from the board signage safety server 50, wherein the inputs 108 are the signals or data received by the board signage safety server 50, and the outputs 100 are the signals or data sent from the board signage safety server 50. The network interface 112 provides the necessary device controller to connect the board signage safety server 50 to one or more networks.

The memory 102 is accessible to the processor 100 and includes processor-executable instructions that, when executed, cause the processor 100 to execute a series of operations. The processor-executable instructions cause the processor 100 to provide an interface for an off-site project manager. The processor-executable instructions also cause the processor 100 to maintain the board signage safety database 54 in the storage 104. As discussed, the board signage safety database 54 may include information about various projects, board signage field crews, signs, board signage establishment plans, and board signage disestablishment plans. In one implementation of the processor-executable instructions, the processor 100 accesses and analyzes a board signage establishment plan and sends a reminder notification, by way of an application, text, or telephone call, for example, to one or more individuals, such as a field crewmember, about an upcoming installation of a sign or a missed installation of a sign.

The processor 100 is caused to receive data from various smart devices, including the smart device 32, and append the data to the board signage safety database 54. Upon receiving an acknowledgement regarding board establishment from the smart device 32, for example, the processor-executable instructions cause the processor 80 to evaluate the acknowledgement and send a verification signal in response. The verification signal may indicate the correct or incorrect establishment of a particular sign.

In one implementation of the processor-executable instructions, the processor 100 accesses and analyzes a board signage disestablishment plan and sends a reminder notification, by way of an application, text, or telephone call, for example, to one or more individuals, such as a field crewmember, about an upcoming dismantling of a sign or a missed installation of a sign. The processor 100 is caused to receive data from various smart devices, including the smart device 32, and append the data to the board signage safety database 54. Upon receiving an acknowledgement regarding board disestablishment from the smart device 32, for example, the processor-executable instructions cause the processor 80 to evaluate the acknowledgement and send a verification signal in response. The verification signal may indicate the correct or incorrect disestablishment of a particular sign. In one embodiment, following the receipt of a signal from the smart device 32 that an incident has occurred, the information and the data stored at the board signage safety database 54 about the particular project is locked and only accessible by designated parties. Further, the processor 100 is caused to issue reports based on the data in the board signage safety database 54.

FIG. 4 conceptually illustrates the software architecture of a board signage safety application 120 of some embodiments that may render information, such as the reports 58 (see FIGS. 1A-1B), and notifications, such as texts and in-app messages, as well as the board signage establishment plan and the board signage disestablishment plan. In some embodiments, the board signage safety application 120 is a stand-alone application or is integrated into another application, while in other embodiments the application might be implemented within an operating system 150. Furthermore, in some embodiments, the board signage safety application 120 is provided as part of a server-based solution or a cloud-based solution. In some such embodiments, the application is provided via a thin client. That is, the application runs on a server while a user interacts with the application via a separate machine or device remote from the server. In other such embodiments, the application is provided via a thick client. That is, the application is distributed from the server to the client machine and runs on the client machine.

The board signage safety application 120 includes a user interface (UI) interaction and generation module 122, management (user) interface tools 124, graphics data tools 126, geolocationing tools 128, the report modules 130, notification/alert modules 132, a database module 134, a field module 136, and a director module 138. The board signage safety application 120 has access to the board signage safety database 54, which in one embodiment, may include pre-existing site data 140, acquired site data 142, board signage libraries 144, activity inventories 146, and presentation instructions 148, which presents instructions for the operation of the board signage safety application 120. In some embodiments, storages 140, 142, 144, 146, 148 are all stored in one physical storage. In other embodiments, the storages 140, 142, 144, 146, 148 are in separate physical storages, or one of the storages is in one physical storage while the other is in a different physical storage.

The board signage safety application 120, in one implementation, provides a database of all pertinent information required for a site including, but not limited to, owner, operator, address, dimensions of work, and specifications describing the nature of work to be performed, materials and equipment to be used and installed and details of structural, mechanical, electrical, plumbing installations, and other utilities as well as right-of-way information, such as roadways and railways. On-site safety information is also preferably included. The pre-existing site data 140 may include all pertinent information required for the site that was pre-existing. Construction-related and maintenance-related forms, such as “Form B,” may be included in the pre-existing site data 140. The board signage safety server 50 may track the life and expiration of such forms and certificates to provide notifications prior to expiration when renewal is required. The pre-existing site data 140 may also include information about job assignments, including having input data on specific questions based on limitation containment in accordance with applicable local, state, and national standards. Such job input information may also include the job ticket specifying a job number and job name assignment. A field crew may be assigned to a job number and job name assignment and the smart device being utilized by the field crew may be employed to send reminders and follow progress. Such information may be provided with a confirmation mechanism. The UI interaction and generation module 122 generates a user interface that allows the end user to specify parameters that may be utilized to generate various reports and notifications.

The pre-existing site data 140 may also include any site plans which may be any type of architectural plan, landscape architecture document, or a detailed engineering drawing of proposed improvements to a given lot. A site plan usually shows a building footprint, travel ways, parking, drainage facilities, sanitary sewer lines, water lines, trails, lighting, landscaping and garden elements, as well as other utilities. The site plan may be provided in a CAD format or other format and may include geolocationing information therein. In one implementation, the site plan may include a computerized representation, such as a computerized grid, of the utilities and the rights-of-way, including railway right-of-ways, at the location. Railway operators and other utility operators may adopt GPS mapping and locating technology to provide the ability to store and retrieve accurate location information nearly instantaneously regarding utilities. Such information may be used as part of the site plans. Furthermore, any observed inconsistencies or changes to the location information can be updated to continuously improve the quality and accuracy of the right-of-way information or other data in the pre-existing site data. Such information and data may include geolocationing data on desired sign locations. This data which augments the pre-existing site data is the acquired site data 142.

The board signage libraries 144 may be all information concerning the type, make, model, and manufacturer of the signs. The activities inventories 146 may include all information about the status of the activities in the project and progress. The presentation instructions 148 may include information and data that permits a user to utilize the board signage safety application 120 and navigate the features therein.

Once the parameters have been established for the generation of reports by default or by an end user utilizing the management (user) interface tools 124, the graphics data tools 126 operate on the site plan or other vector graphics data files with texture identifiers or two or three dimensional map image files specified in one or more map tiles that may be raster-based map tiles, for example. The graphics data tools 126 create the augmented data for the site plan to determine the signs and sign locations and calendar for the signs, including the board signage establishment plan and the board signage disestablishment plan. The geolocationing tools 128 interfaces with the geolocationing data embedded in the site plan and the geolocationing data provided on-site by the smart device, for example. This geolocationing information supports the graphics data tools 126 and the augmentation of the site plan. The report modules 130 may be executed to containerize and annotate the data elements to generate the required report or reports. Additionally, by way of example, the reports modules 130 may generate sign usage reports that allow an owner to determine actual hours of use for financial evaluation of each sign program.

The notification/alert modules 132 may be executed to provide notifications of varying levels of urgency to the field crew, field crewmembers, or the off-site project manager 56. The notifications and alerts may be sign related as previously discussed and include notifications and alerts about upcoming establishments, disestablishments or in-progress establishments and disestablishments. The database module 134 may be executed to obtain data from the board signage safety database 54. The field module 136 provides the necessary interface or interfaces for the field crews, and, similarly, the director module 138 provides the necessary interface or interfaces for project directors.

In the illustrated embodiment, FIG. 4 also includes an operating system 150 that includes input device driver(s) 152 and a display module 154. In some embodiments, as illustrated, the input device drivers 152 and display module 154 are part of the operating system 150 even when the board signage safety application 120 is an application separate from the operating system 150. The input device drivers 152 may include drivers for translating signals from a keyboard, mouse, touchpad, tablet, touch screen, gyroscope, or accelerometer, for example. A user may use one or more of these input device drivers 152, which send signals to their corresponding device driver, in combination with the display module 154 to interact with the board signage safety application 120. The device driver then translates the signals into user input data that is provided to the UI interaction and generation module 122.

As discussed, during the maintenance of railroads, board signage is utilized to protect trains, train crews, contractors, and anyone performing work within a railway right-of-way. The board signage informs the individuals in the area of the conditions and provide guidance that prioritizes safety. The board signage safety system presented herein ensures timely installation or “establishment” of board signage and the timely dismantling or “disestablishment” of the board signage through the use of a geolocation-based system that provides reminders, plans, and verification of work completed.

It should be appreciated, however, that the teachings presented herein are not limited to board signage related to performing work within a railway right-of-way on a railroad. More generally, the teachings presented herein are applicable to any industry using signage that may be periodically installed and later dismantled. Such industries include agricultural, manufacturing, construction, oil and gas, transportation, as well as service industries, including delivery and security. By way of example and not by way of limitation, with respect to the agricultural industry, in forestry, signage may be deployed near and within a logging operation and later dismantled. In the manufacturing industry at a steel plant, signage may be deployed to provide guidance to drivers and the signage may later be dismantled.

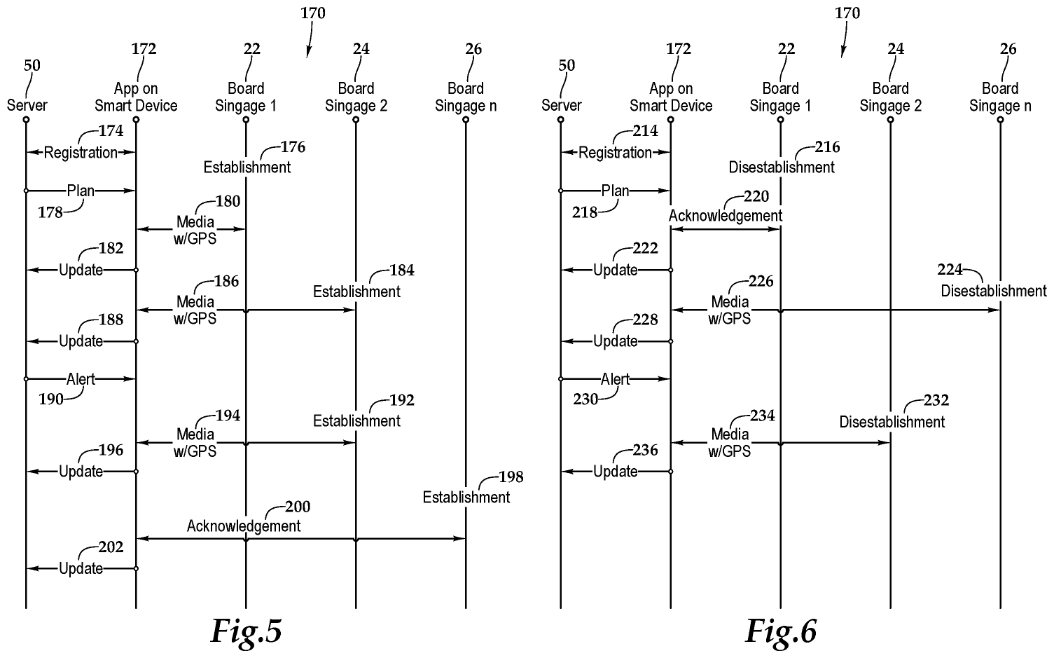

Referring now to FIG. 5, a signalization diagram 170 depicts one embodiment of signal communication during an establishment of board signage. As shown, an application 172 is installed on a smart device, such as the smart device 32. In some embodiments, the signalization begins with a registration 174 of the application 172 with the board signage safety server 50. A board signage establishment plan 176 is accessed by the application 172. Following the board signage establishment plan 176, the board signage 22 is established at establishment 178 and then media with GPS data 180 is captured by the application 172 and sent as an update 182 to the server. Continuing with the board signage establishment plan 176, the board signage 24 is then established at establishment 184 with media with GPS data 186 being captured by the application 172 and sent to the board signage safety server 50 as an update 188. In this instance, the board signage safety server 50 determines that the board signage 24 was established in the incorrect location. An alert 190 is provided by the board signage safety server 50 to the application 172. The board signage 24 is then established in the proper location at establishment 192 with media with GPS data 194 being provided to the board signage safety server 50 via an update 196. Then, continuing with the board signage establishment plan, the board signage 26 is established at establishment 198 with an acknowledgement 200 that does not contain media being provided to the board signage safety server 50 via an update 202.

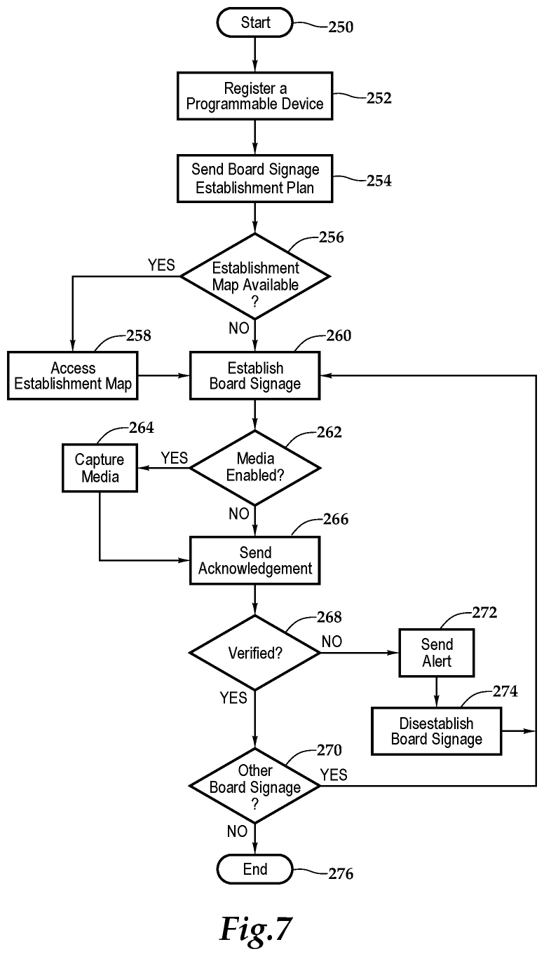

Referring now to FIG. 6, a signalization diagram depicts one embodiment of signal communication during a disestablishment of board signage. As shown, an application 172 is installed on a smart device, such as the smart device 32. In some embodiments, the signalization begins with a registration 214 of the application 172 with the board signage safety server 50. A board signage disestablishment plan 216 is accessed by the application 172 to determine the schedule and location of the signs to be dismantled. Following the board signage disestablishment plan 216, the board signage 22 is disestablished at disestablishment 218 and then an acknowledgement 220 of the dismantling is provided to the board signage safety server 50 via an update 222. Continuing with the board signage disestablishment plan 216, the board signage 26 is then disestablished at disestablishment 224 with media with GPS data 226 being captured by the application 172 and sent to the board signage safety server 50 as an update 228. In this instance, the board signage safety server 50 determines that the board signage 24 was disestablished in the incorrect order and board signage 24 was missed. An alert 230 is provided by the board signage safety server 50 to the application 172. The board signage 24 is then disestablished at disestablishment 232 with media with GPS data 234 being provided to the board signage safety server 50 via an update 236. As previously discussed, typically, railway workers and other field crewmembers rely on manual logs to record the establishment and disestablishment. This can result in misplaced signs with respect to establishment, forgotten signs with respect to disestablishment, and other errors. The board signage establishment and disestablishment plans presented herein, in combination with the systems described herein, mitigate the risks of these errors to provide efficient board signage establishment and disestablishment.

Referring to FIG. 7, one embodiment of a method for utilizing a board signage safety system and providing board signage safety is shown. The methodology starts at block 250 and progresses to block 252 where a smart device is registered with the board signage safety server and, if necessary, any required application downloads and installation occur as well as registration of the contact information, including phone number or email address, of the smart device with the board signage safety server. At block 254, a board signage establishment plan is sent from the board signage server to the smart device. At this time, the board signage establishment plan may be integrated into a calendar associated with the smart device to further aid reminders as well as tracking of progress. In one embodiment, as part of the board signage establishment plan, in-app notifications and texts may be sent to the smart device to remind the user, such as a field crewmember, of upcoming board signage establishment dates, times, and other scheduling information.

At decision block 256, if an establishment map is available as part of the board signage establishment plan, then the establishment map is accessed at block 258 before proceeding to block 260. The establishment map may show locations with GPS data and preferred routing information for establishment of a series of signs. On the other hand, if an establishment map is not available, then the methodology proceeds from decision block 256 to block 260. At block 260, the board signage is established. At decision block 262, if the board signage establishment plan and the smart device are enabled for media then media, such as photographs or video of the board establishment, is captured at block 264 before the methodology continues to block 266. If media is not enabled, then from decision block 262 the methodology proceeds directly to block 266.

At block 266, the smart device sends an acknowledgement of the establishment of the sign to the server. In one embodiment, a GPS unit associated with the smart device determines the location of the board signage establishment for the acknowledgement. If media is enabled, then the media is sent as part of the establishment. At decision block 268, the board signage safety server 50 verifies the acknowledgment and associated establishment of the sign. If the establishment is verified, then the methodology advances to decision block 270. On the other hand, if the establishment is not verified, then an alert is sent to the smart device of the field crew at block 272 and the sign is disestablished at block 274 before the methodology returns to block 260 for establishment—or re-establishment—of the sign. Returning to decision block 270, if other board signage requires establishment as part of the board establishment plan, then the methodology returns to block 260. If all board establishment has completed, then the methodology advances from decision block 270 to an end at block 276.

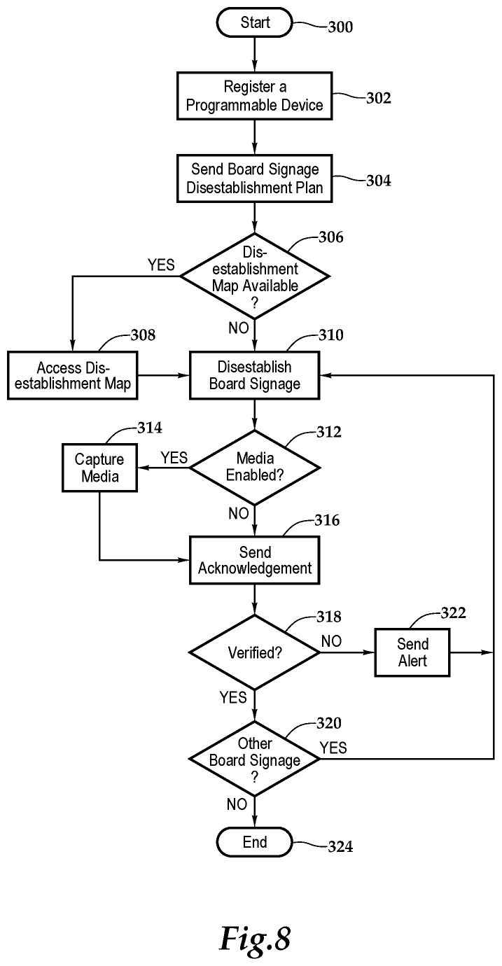

Referring to FIG. 8, another embodiment of a method for utilizing a board signage safety system and providing board signage safety is shown. The methodology starts at block 300 and progresses to block 302 where a smart device is registered with the board signage safety server and, if necessary, any required application downloads and installation occur as well as registration of the contact information, including phone number or email address, of the smart device with the board signage safety server. At block 304, a board signage disestablishment plan is sent from the board signage server to the smart device. In one embodiment, as part of the board signage disestablishment plan, in-app notifications and texts may be sent to the smart device to remind the user, such as a field crewmember, of upcoming board signage disestablishment dates, times, and other scheduling information. At this time, the board signage disestablishment plan may be integrated into a calendar associated with the smart device to further aid reminders as well as tracking of progress.

At decision block 306, if a disestablishment map is available as part of the board signage disestablishment plan, then the disestablishment map is accessed at block 308 before proceeding to block 310. The disestablishment map may show locations with GPS data and preferred routing information for disestablishment of a series of signs. On the other hand, if a disestablishment map is not available, then the methodology proceeds from decision block 306 to block 310. At block 310, the board signage is disestablished. At decision block 312, if the board signage disestablishment plan and the smart device are enabled for media then media, such as photographs or video of the board disestablishment, is captured at block 314 before the methodology continues to block 316. If media is not enabled, then from decision block 312 the methodology proceeds directly to block 316.

At block 316, the smart device sends an acknowledgement of the disestablishment of the sign to the server. In one embodiment, a GPS unit associated with the smart device determines the location of the board signage disestablishment for the acknowledgement. If media is enabled, then the media is sent as part of the establishment. At decision block 318, the board signage safety server verifies the acknowledgment and associated disestablishment of the sign. If the disestablishment is verified, then the methodology advances to decision block 320. On the other hand, if the disestablishment is not verified, then an alert is sent to the smart device of the field crew at block 322 and the sign is established at block 324 before the methodology continues to decision block 320. At decision block 320, if other board signage requires disestablishment as part of the board disestablishment plan, then the methodology returns to block 310. If all board disestablishment has completed, then the methodology advances from decision block 320 to an end at block 326.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A board signage safety system (10), the system (10) comprising:
a plurality of signs (22-30); and
non-transitory memory (82) accessible to a processor (80), the non-transitory memory (82) including processor-executable instructions that, when executed, by the processor (80) cause the system (10) to:
receive a board signage establishment plan from a remote server (50), the board signage establishment plan including a schedule of sign establishment locations and sign identification data for each of the plurality of signs (22-30),
establish a pairing with a particular sign according to the board signage establishment plan, the particular sign being one of the plurality of signs (22-30),
in response to establishment of the particular sign, send an acknowledgement to the remote server (50), the acknowledgment including the sign identification data and global positioning system data relative to the particular sign, and
receive a verification signal from the remote server, the verification signal indicating a verification status of the establishment of the particular sign.

2. The system (10) as recited in claim 1, wherein the verification signal further comprises a notification of correct installation relative to the establishment of the particular sign.

3. The system (10) as recited in claim 1, wherein the verification signal further comprises a notification of incorrect installation relative to the establishment of the particular sign.

4. The system (10) as recited in claim 1, wherein the acknowledgment further comprises a confirmation of installation of the establishment of the particular sign.

5. The system (10) as recited in claim 1, wherein the acknowledgment further comprises a confirmation including media of installation of the establishment of the particular sign.

6. The system (10) as recited in claim 1, wherein the processor-executable instructions further comprise processor-executable instructions that, when executed, by the processor (80) cause the system (10) to:
receive a board signage disestablishment plan from a remote server (50), the board signage disestablishment plan including a schedule of sign disestablishment locations and sign identification data for each of the plurality of signs (22-30)
in response to disestablishment of the particular sign, send an acknowledgement to the remote server (50), the acknowledgment including sign identification data and global positioning system data relative to the particular sign, and
receive a verification signal from the remote server (50), the verification signal indicating a verification status of the disestablishment of the particular sign

7. The system (10) as recited in claim 6, wherein the verification signal further comprises a notification of correct dismantling relative to the disestablishment of the particular sign.

8. The system as recited in claim 1, wherein the plurality of signs (22-30) relate to a project selected from the group consisting of railway maintenance, railway construction, delivery services, oil industry installations, home inspection sites, and security of premises.

9. A method for board signage safety, method comprising:
creating a board signage establishment plan at a server (50), the board signage establishment plan including a schedule of sign establishment locations and sign identification data for each of a plurality of signs (22-30);
sending the board signage establishment plan from the server (50) to a smart device (32), the server (50) and the smart device (32) being respectively remote;
establishing a pairing with a particular sign according to the board signage establishment plan, the particular sign being one of the plurality of signs (22-30);
sending, in response to establishment of the particular sign, an acknowledgement from the smart device (32) to the server (50), the acknowledgment including sign identification data and global positioning system data relative to the particular sign; and
receiving a verification signal from the remote server (50), the verification signal indicating a verification status of the establishment of the particular sign.

10. A method for board signage safety, method comprising:
creating a board signage establishment plan at a server (50), the board signage establishment plan including a schedule of sign establishment locations and sign identification data for each of a plurality of signs (22-30);
sending the board signage establishment plan from the server (50) to a smart device (32), the server (50) and the smart device (32) being respectively remote;
integrating the board signage establishment plan into a calendar associated with the smart device (32);
establishing a pairing with a particular sign according to the board signage establishment plan, the particular sign being one of the plurality of signs (22-30);
sending, in response to establishment of the particular sign, an acknowledgement from the smart device (32) to the server (50), the acknowledgment including sign identification data and global positioning system data relative to the particular sign;
receiving a verification signal from the remote server (50) at the smart device (32), the verification signal indicating a verification status of the establishment of the particular sign;
creating a board signage disestablishment plan at the server (50), the board signage establishment plan including a schedule of sign establishment locations and sign identification data for each of the plurality of signs (22-30);
sending the board signage disestablishment plan from the server (50) to the smart device (32);
integrating the board signage establishment plan into the calendar associated with the smart device (32);
sending, in response to disestablishment of the particular sign, an acknowledgement to the remote server (50), the acknowledgment including sign identification data and global positioning system data relative to the particular sign; and
receiving a verification signal from the remote server (50) at the smart device (32), the verification signal indicating a verification status of the disestablishment of the particular sign.
